(19) United States
(12) Patent Application Publication
(10) Pub. No.: US 2026/0310786 A1
(43) Pub. Date: Oct. 8, 2026

(54) A MALWARE DETECTION SYSTEM AND METHOD

(71) Applicant: CyTwist LTD., Ramat Gan (IL)

(72) Inventors: Yosef KORAKIN, Ramat Gan (IL); Yehonadav HERTZ, Ramat Gan (IL); Moshe FURMAN, Ramat Gan (IL); Oren BAHAR, Ramat Gan (IL); Micha Sharon TAL, Ramat Gan (IL)

(21) Appl. No.: 19/481,186

(22) PCT Filed: May 2, 2024
(86) PCT No.: PCT/IL2024/050415

§ 371 Date: Nov. 4, 2025

Related U.S. Application Data
(60) Provisional application No. 63/499,986, filed on May 4, 2023.

(51) Int. Cl. G06F 21/56

(52) U.S. Cl. CPC G06F 21/566; G06F 2221/033

(57) ABSTRACT

A malware detection system comprising a processing circuitry configured to: generate one or more create-load events, each generated upon determining at least one file being loaded or attempted to be loaded into a memory of an endpoint before a pre-determined period of time passing from creation of the file on the endpoint, each create-load event is associated with the respective file; determine, utilizing one or more evidence scoring rules, a probability indicator for at least some of the create-load events, the probability indicator being indicative of a probability that the file associated with the respective create-load event comprises malicious code; and alert a user of the malware detection system upon the probability indicator of at least one create-load event being above a threshold.

### TECHNICAL FIELD

The invention relates to a malware detection system and method.

### BACKGROUND

The term “malware”, which is short for malicious software, is used to refer to any software designed to infiltrate or damage a computer system without the owner's informed consent. Malware can include viruses, worms, trojan horses, rootkits, adware, spyware, and any other malicious and unwanted software. Many endpoint devices, such as desktop personal computers (PCs), laptops, smartphones, personal data assistants, servers, routers, switches, security devices, Virtual Machines (VMs) and any other endpoints that are connected to a network, can be at risk of an attack from malware.

Computer users will typically run antivirus and/or Endpoint Detection and Response (EDR) software applications, to detect malware and protect against malware attacks on their endpoint. Detecting malware is challenging, as malware is usually designed to be difficult to detect, often employing technologies that deliberately hide the presence and processes of malware on an endpoint or within a network of endpoints. Consequently, anti-virus and EDR applications will use a large number of techniques in order to detect malware most effectively and reduce the risk of any malware going undetected.

Current malware detection techniques focus on signatures of files suspected as malware and on runtime anomalies of processes that behave outside the norm of a regular operation. These signature and behavioral approaches result in an inability of said techniques to determine that a process which acts within the norm when creating and loading files is actually malware. These current malware detection approaches focus on specific signatures and on given behaviors of malwares and do not identify high level behavioral patterns of the attacker, thereby triggering a “cat and mouse” chase between malware developers and the malware detection systems.

Thus, there is a need in the art for a new malware detection system and method that can identify high level behavioral patterns of malware.

### GENERAL DESCRIPTION

In accordance with a first aspect of the presently disclosed subject matter, there is provided a malware detection system comprising a processing circuitry configured to: generate one or more create-load events, each generated upon determining at least one file being loaded or attempted to be loaded into a memory of an endpoint before a pre-determined period of time passing from creation of the file on the endpoint, each create-load event is associated with the respective file; determine, utilizing one or more evidence scoring rules, a probability indicator for at least some of the create-load events, the probability indicator being indicative of a probability that the file associated with the respective create-load event comprises malicious code; and alert a user of the malware detection system upon the probability indicator of at least one create-load event being above a threshold.

In some cases, the processing circuitry is further configured to: obtain a file creation list being a list of files created or attempted to be created on the endpoint during a first time-window and a respective time of creation or attempted creation of each file in the list; obtain a file load list being a list of files loaded or attempted to be loaded into the memory of the endpoint during a second time-window and a respective time of loading or attempted loading of each file in the list into the memory; and wherein the generate is based on an analysis of the file creation list and the file load list.

In some cases, the processing circuitry is further configured to: obtain a log of events occurring on the endpoint during the first time-window and during the second time-window; and wherein the file creation list and the file load list are based on an analysis of the log.

In some cases, the first time-window and the second time-window are identical.

In some cases, the file creation list and the file load list are obtained periodically or continuously and wherein the generate, the determine and the alert are performed periodically or continuously while maintaining at least part of the previously identified create-load events.

In some cases, the log is obtained periodically or continuously.

In some cases, the one or more evidence scoring rules include one or more of: (a) the probability indicator is greater upon the file associated with the respective create-load event is an only file created by another file; (b) the probability indicator is greater upon the file associated with the respective create-load event is created by another file and a number of files created by the another file is below a number of created files threshold; (c) the probability indicator is greater upon the file associated with the respective create-load event is part of a group of files above a group size threshold; (d) the probability indicator is greater upon the execution of the file associated with the respective create-load event includes communicating with the internet; (e) the probability indicator is greater upon the execution of a child-file created by the file associated with the respective create-load event includes communicating with the internet; (f) the probability indicator is greater upon the execution of the file associated with the respective create-load event includes persistence; or (g) the probability indicator is greater upon the execution of a child-file created by the file associated with the respective create-load event includes persistence.

In some cases, the group of files comprises one or more files that: (a) were created on the endpoint, (b) were created within a third time-window, and (c) have a given integrity level.

In some cases, the processing circuitry is further configured to: recognize patterns within the one or more create-load events having probability indicator above a second threshold.

In accordance with a second aspect of the presently disclosed subject matter, there is provided a malware detection method comprising: generating, by a processing circuitry, one or more create-load events, each generated upon determining at least one file being loaded or attempted to be loaded into a memory of an endpoint before a pre-determined period of time passing from creation of the file on the endpoint, each create-load event is associated with the respective file; determining, by the processing circuitry, utilizing one or more evidence scoring rules, a probability indicator for at least some of the create-load events, the probability indicator being indicative of a probability that the file associated with the respective create-load event comprises malicious code; and alerting, by the processing circuitry, a user of the malware detection system upon the probability indicator of at least one create-load event being above a threshold.

In some cases, the malware detection method further comprising: obtaining, by the processing circuitry, a file creation list being a list of files created or attempted to be created on the endpoint during a first time-window and a respective time of creation or attempted creation of each file in the list; obtaining, by the processing circuitry, a file load list being a list of files loaded or attempted to be loaded into the memory of the endpoint during a second time-window and a respective time of loading or attempted loading of each file in the list into the memory; and wherein the generating is based on an analysis of the file creation list and the file load list.

In some cases, the malware detection method further comprising: obtaining, by the processing circuitry, a log of events occurring on the endpoint during the first time-window and during the second time-window; and wherein the file creation list and the file load list are based on an analysis of the log.

In some cases, the first time-window and the second time-window are identical.

In some cases, the file creation list and the file load list are obtained periodically or continuously and wherein the generating, the determining and the alerting are performed periodically or continuously while maintaining at least part of the previously identified create-load events.

In some cases, the log is obtained periodically or continuously.

In some cases, the one or more evidence scoring rules include one or more of: (a) the probability indicator is greater upon the file associated with the respective create-load event is an only file created by another file; (b) the probability indicator is greater upon the file associated with the respective create-load event is created by another file and a number of files created by the another file is below a number of created files threshold; (c) the probability indicator is greater upon the file associated with the respective create-load event is part of a group of files above a group size threshold; (d) the probability indicator is greater upon the execution of the file associated with the respective create-load event includes communicating with the internet; (e) the probability indicator is greater upon the execution of a child-file created by the file associated with the respective create-load event includes communicating with the internet; (f) the probability indicator is greater upon the execution of the file associated with the respective create-load event includes persistence; or (g) the probability indicator is greater upon the execution of a child-file created by the file associated with the respective create-load event includes persistence.

In some cases, the group of files comprises one or more files that: (a) were created on the endpoint, (b) were created within a third time-window, and (c) have a given integrity level.

In some cases, the malware detection method further comprising: recognizing, by the processing circuitry, patterns within the one or more create-load events having probability indicator above a second threshold.

In accordance with a third aspect of the presently disclosed subject matter, there is provided a non-transitory computer readable storage medium having computer readable program code embodied therewith, the computer readable program code, executable by processing circuitry of a computer to perform a malware detection method, the malware detection method comprising: generating, by a processing circuitry, one or more create-load events, each generated upon determining at least one file being loaded or attempted to be loaded into a memory of an endpoint before a pre-determined period of time passing from creation of the file on the endpoint, each create-load event is associated with the respective file; determining, by the processing circuitry, utilizing one or more evidence scoring rules, a probability indicator for at least some of the create-load events, the probability indicator being indicative of a probability that the file associated with the respective create-load event comprises malicious code; and alerting, by the processing circuitry, a user of the malware detection system upon the probability indicator of at least one create-load event being above a threshold.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of an exemplary timeline of files being created (or attempted to be created) and of files loaded into memory (or attempted to be loaded into memory), in accordance with the presently disclosed subject matter;

FIG. 2 is a block diagram schematically illustrating one example of a malware detection system, in accordance with the presently disclosed subject matter; and

FIG. 3 is a flowchart illustrating one example of a sequence of operations carried out for malware detection, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “generating”, “collecting”, “determining”, “identifying”, “alerting”, “predicting”, “recognizing”, “performing”, “analyzing”, “triggering”, “negating”, “canceling” or the like, include action and/or processes of a computer that manipulate and/or transform data into other data, said data represented as physical quantities, e.g., such as electronic quantities, and/or said data representing the physical objects. The terms “computer”, “processor”, “processing resource”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

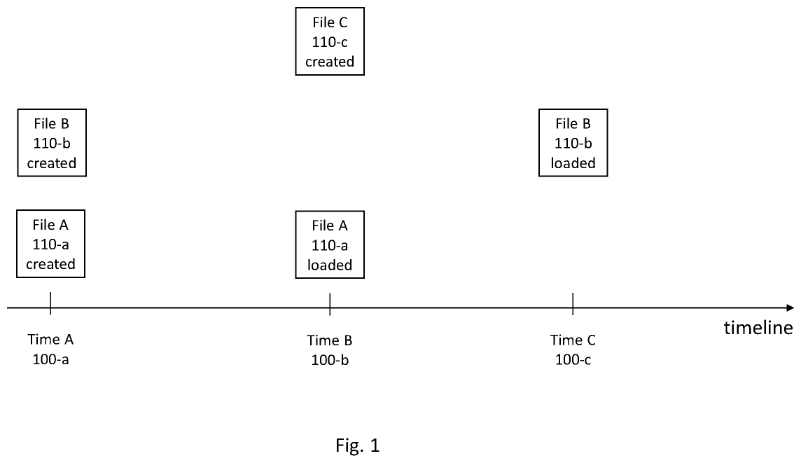

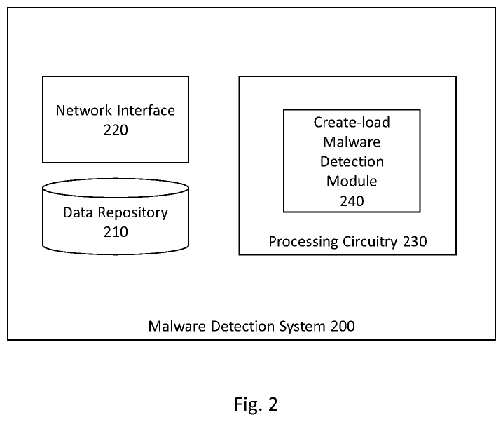

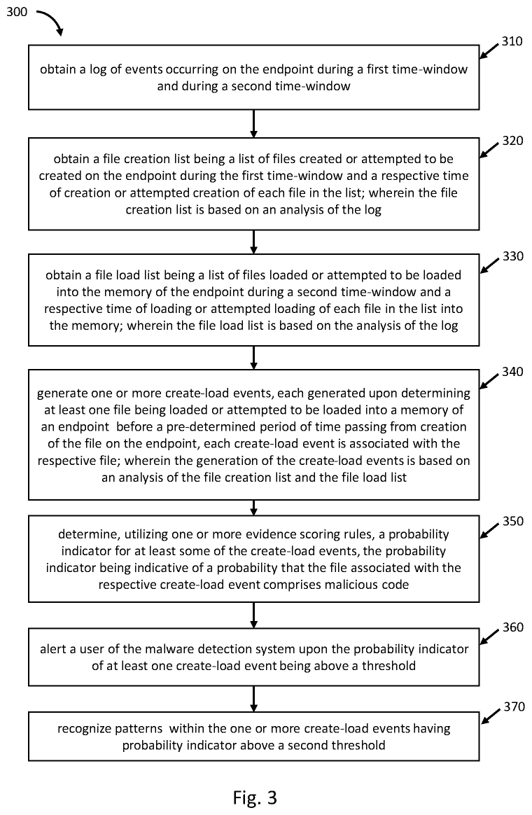

In embodiments of the presently disclosed subject matter, fewer, more and/or different stages than those shown in FIG. 3 may be executed. In embodiments of the presently disclosed subject matter one or more stages illustrated in FIG. 3 may be executed in a different order and/or one or more groups of stages may be executed simultaneously. FIGS. 1-2 illustrate a general schematic of the system architecture in accordance with an embodiment of the presently disclosed subject matter. Each module in FIGS. 1-2 can be made up of any combination of software, hardware and/or firmware that performs the functions as defined and explained herein. The modules in FIGS. 1-2 may be centralized in one location or dispersed over more than one location. In other embodiments of the presently disclosed subject matter, the system may comprise fewer, more, and/or different modules than those shown in FIGS. 1-2.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Prior-art malware detection solutions focus on trying to find a malware attack by looking for specific signatures and trying to identify given behaviors of the malware attack. The herein described malware detection system identifies, by contrast, high level behavioral patterns of the attacker, thereby providing a flexible solution that can identify high level behavioral patterns of malware even when their specific attack tactics change. A non-limiting example of a malware is Qbot (also known as: Qakbot or Pinkslipbot) is a modular multi-staged malware with backdoor capabilities. Qbot is classified as a banking trojan, worm, and Remote Access Trojan (RAT), Qbot steals sensitive data and attempts to self-propagate to other systems on the network. Qbot also provides Remote Code Execution (RCE) capabilities, allowing attackers to perform manual attacks to achieve secondary objectives such as scanning the compromised network or injecting ransomware. This malware inserts malicious code into an endpoint that is used to exploit the endpoint's vulnerabilities. The Qbot malware is multi-modal and multi-staged—Qbot is introduced to an endpoint by a first-stage downloader malware-—as part of the initial exploit or soon after initial access is gained. Initial access breaches can happen via multiple techniques, such as malware spam or email phishing with a trojanized document, exploiting a public-facing vulnerability, or malicious insider attacks. Once operating on an endpoint system, Qbot extracts an exploit kit that it uses to steal credentials and spread to other endpoints on the network. The malware uses a split run or split attack strategy to avoid detection by prior-art anti-virus and EDR software. A split attack is instrumented in the malware breaking down the exploit kit, and other software it may need in order to operate, into parts and extracts each part separately. Each part is loaded and run disjointedly—thereby creating a pattern of multiple standalones create and load events. These multiple standalones create and load events are utilized by the herein described malware detection system as a tell-tale sign of a malware attack. It is to be noted that such split run behavior is uncharacterized of non-malware software which usually extracts multiple files required for their operation at once and do not split the extraction to many singulars create-load events.

Bearing this in mind, attention is drawn to FIG. 1, is a schematic illustration of an exemplary timeline of files being created on an endpoint (or attempted to be created on the endpoint) and of files loaded into memory of the endpoint (or attempted to be loaded into memory of the endpoint), in accordance with the presently disclosed subject matter.

The malware detection system obtains information of events occurring on one or more endpoints. An endpoint can be any real or virtual computerized device that has the ability to load code contained in files into memory. Theses endpoints can include desktop PCs, laptops, smartphones, personal data assistants, servers, routers, switches, security devices, Virtual Machines (VMs) and any other endpoint. The endpoints can be connected to one or more networks and/or disconnected temporeraly or permanently from one or more of the networks. The events can include any event occurring on one or more of the endpoints (e.g., on endpoints monitored by the malware detection system), for example: process creation events, process attempted creation events (events of creation attempts that failed), file creation events, file attempted creation events (events of creation attempts that failed), process load events, process attempted load events (events of attempts to load the process that failed), file load events, file attempted load events (events of load attempts that failed), folder creation, name changes of files, processes and folders and any other event that can occur on an endpoint system. Each event can be optionally associated with one or more event parameters. For example, an attempted file creation event can be associated with the file that was attempted to be created. Each event can be further associated with a timestamp, indicating the time the event occurred on the endpoint.

The malware detection system can analyze events from one or more endpoints to detect malware based on the pattern of file creation (and/or file creation attempts) and file loading (and/or file loading attempts) on a given endpoint. The pattern of creation and load events can be for example determining the time passed between a creation (or attempt to create) of a given file or a given process on a given endpoint and the loading (or attempted loading) of that same file or that same process into the memory of the given endpoint. If the time passed is below a given threshold, the malware detection system can determine that a create-load event has occurred on the endpoint. The malware detection system can generate a create-load event and optionally associate it with an event parameter of the corresponding file or process. It is to be noted that “file” and “process” are used interchangeably throughout the description.

These create-load events are used by the malware detection system to detect malware that is trying a split run—the malware uses the split run strategy to avoid detection by prior-art anti-virus and EDR software. The described malware detection system can detect these split runs where the malware is breaking down the software it may need in order to operate, into parts and extracts each part separately. The malware tries to create and load each part disjointedly from the others—thereby creating the pattern of split run—multiple standalones create and load events with a relative short time passing between them that is identified by the malware detection system.

FIG. 1 depicts a non-limiting exemplary collection of events occurring on a given endpoint during a time-window. The events are depicted on a timeline for sake of the comprehensibility of the figure.

Time A 100-a, time B 100-b and time C 100-c are non-limiting exemplary timepoints occurring within the time-window. As shown on the timeline, time A 100-a occurred before time B 100-b which occurred before time C 100-c. In our non-limiting example, file A 110-a was created (or attempted to be created) on the given endpoint on time A 100-a. The same file A 110-a was loaded (or attempted to be loaded) into the memory of the given endpoint on time B 100-b. File B 110-b was created (or attempted to be created) on the given endpoint on time A 100-a. The same file B 110-b was loaded (or attempted to be loaded) into the memory of the given endpoint on time C 100-c. File C 110-c was created (or attempted to be created) on the given endpoint on time B 100-b. The same file C 110-c was not load (or attempted to be loaded) into the memory of the given endpoint within the time-window.

In this non-limiting example, the malware detection system can determine the time passed between the creation (or attempt to create) of a given file or a given process on a given endpoint and the loading (or attempted loading) of that same file or that same process into the memory of the given endpoint. If the time passed is below a given threshold, the malware detection system can determine that a create-load event has occurred on the endpoint. It can be assumed, for the sake of example, that the time passed between time A 100-a and time B 100-b is within the given threshold and that the time passed between time A 100-a and time C 100-c is above the given threshold. In this case, the malware detection system will generate a create-load event for file A 110-a, because the time passed between creation (or attempt creation) and load (or attempted loading) of file A 110-a is below the given threshold. The generated create-load event can have an association to file A 110-a which means that the malware detection system will have access to metadata and/or the file itself through the generated create-load event. The malware detection system will not generate a create-load event for file B 110-b in our non-limiting example, because the time passed between creation (or attempt creation) and load (or attempted loading) of file B 110-b is above the given threshold. The malware detection system will not generate a create-load event for file C 110-c in our non-limiting example, because this file was created (or attempted to be created) within the time-window, but was not loaded (or attempted to be loaded) within the same time-window.

Continuing our non-limiting example above, featuring the Qbot malware, this malware utilizes split run tactic by breaking down the exploit kit, and other software it may need in order to operate, into parts-extracting each time just one part and loading each time just that part. The malware detection system will generate multiple create-load events for such a Qbot attack. Identifying each part extraction as a file creation (or attempted creation) and each part run as the loading (or attempted loading) of that file into memory within a time threshold. It is to be noted that a non-malware software will likely extract all software parts required for its operation at once, thus not generating create-load events.

The malware detection system applies a high-level approach to identifying malware by determining events of files created (or attempted to be created) on a given endpoint and loaded (or attempted to be loaded) into a memory of the given endpoint. Once the malware detection system generated the create-load events, the malware detection system can further determine probability indicators for the create-load events an alert a user of the malware detection system of a potential malware upon the probability indicators for one or more create-load events is above a threshold, as further detailed herein, inter alia with reference to FIG. 3.

This malware detection system is more efficient than current malware detection systems as it requires monitoring of fewer events and results in less false positive alerts.

Having briefly described an exemplary timeline of files being created (or attempted to be created) and of files being loaded into memory (or attempted to be loaded into memory) of a given endpoint, attention is drawn to FIG. 2, is a block diagram schematically illustrating one example of a malware detection system, in accordance with the presently disclosed subject matter.

According to certain examples of the presently disclosed subject matter, a malware detection system 200 (also referred herein as: “malware detection system” or “system”) comprises a network interface 220 enabling connecting the malware detection system 200 to a network, for example: to an organizational network, and enabling it to send and receive data sent thereto through the network, including in some cases receiving event information collected from computerized endpoints of the network. In some cases, the network interface 220 can be connected to the Internet.

Malware detection system 200 can receive event data from one or more endpoints and/or one or more log files comprising data of events occurring on one or more endpoints. The malware detection system 200 can be a standalone system. In some cases, the malware detection system 200 is part of another organizational security system, such as: EDR or Security Information and Event Management (SIEM) systems. In some cases, at least part of malware detection system 200 can be installed on one or more cloud computing platforms. For example, as a serverless function running on a cloud platform. In some cases, at least part of the organizational network is installed on one or more cloud computing platforms.

Malware detection system 200 can further comprise or be otherwise associated with a data repository 210 (e.g., a database, a storage system, a memory including Read Only Memory—ROM, Random Access Memory—RAM, or any other type of memory, etc.) configured to store data, including, inter alia, one or more log files containing data of events occurring on one or more endpoints, events occurring on one or more endpoints, and specifically: file create (or attempted to be created) events, file load (or attempted to be loaded) events, create-load events generated by malware detection system 200, etc. In some cases, data repository 210 can be further configured to enable retrieval and/or update and/or deletion of the data stored thereon. It is to be noted that in some cases, data repository 210 can be distributed. It is to be noted that in some cases, at least part of data repository 210 can be stored in on a cloud-based storage.

Malware detection system 200 further comprises processing circuitry 230. Processing circuitry 230 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant organizational malware detection system 200 resources and for enabling operations related to organizational malware detection system 200 resources.

The processing circuitry 230 comprises a create-load malware detection module 240.

Create-load malware detection module 240 can be configured to perform a malware detection process, as further detailed herein, inter alia with reference to FIG. 3.

Turning to FIG. 3, there is shown a flowchart illustrating one example of a sequence of operations carried out for malware detection process, in accordance with the presently disclosed subject matter.

Malware detection system 200 can obtain a log file comprising event data from one or more endpoints. The events in the log files are events occurring on the endpoints during a given time-window or time-frame. These events include file creation (or attempted creation) and file loading (or attempted loading) into memory. These events can be associated with timestamps indicating the time the event occurred. These events can be associated with the corresponding files. The malware detection system 200 can utilize the log file to create a file creation list being a list of files created or attempted to be created on a given endpoint of the endpoints during a first time-window that is within the given time-frame. The malware detection system 200 can also utilize the log file to create a file load list being a list of files loaded or attempted to be loaded into the memory of the endpoint during a second time-window that is within the given time-frame. The malware detection system 200 can generate create-load events, which are events where the time passed between creation (or attempted creation) of a given file on a given endpoint and the loading (or attempted loading) of that given file to a memory of the given endpoint is below a threshold (for example, a threshold of 30 minutes). These create-load events are a sign of a split run by a malware trying to extract the software it requires while keeping it undetected by prior-art malware detection solution. In order to determine is these create-load events are evidence of an actual malware attack conducted on the given endpoint, the malware detection system 200 utilizes a set of evidence scoring rules to determine a probability indicator for at least one of the create-load events. The probability indicator being indicative of a probability that the file associated with the respective create-load event comprises malicious code and that a malware attack is actually being conducted on the given endpoint. A non-limiting example of an evidence scoring rule is checking if the execution of the file associated with the respective create-load event includes communicating with the internet. The probability indicator is greater upon determining that the execution of the file associated with the respective create-load event actually attempted (and/or succeeded) to communicate over a network. Another non-limiting example of an evidence scoring rule is checking if the file associated with the respective create-load event is part of a group of files above a group size threshold. The probability indicator is greater upon the size of the group is greater. The group of files comprises one or more files that were created on the given endpoint, were created within a third time-window, and have a given integrity level (for example, have the same type and level of permissions for creating and running these files). The malware detection system 200 can optionally recognize patterns within the one or more create-load events having probability indicator above a second threshold. These patterns can include a create-load event that is reoccurring every period of time (such as: every day, every week, on specific times, etc.). The malware detection system 200 can alert a user of the system upon the probability indicator of at least one create-load event being above a certain threshold. The user can be for example a cyber analyst that can look into a log of the given endpoint and determine is a malware attack is (or has been) conducted on that given endpoint. The malware detection system 200 can optionally also take other actions, including automatic prevention and mitigation actions on the given endpoint.

Continuing the non-limiting example above, a Qbot malware that is conducting an attack a given endpoint utilizes a split run tactic. In this example, the Qbot malware extract one part of the exploit kit as a file (for example: as a “calc.exe” file replacing the authentic calculator application installed on the endpoint). The replacement “calc.exe” file is loaded into the memory of the endpoint within the time threshold and the malware detection system 200 generates a create-load event for it. This first event is associated with the “calc.exe” file. Next, the malware creates a “windowsCodecs.dll” file on that same endpoint. The “windowsCodecs.dll” file is loaded into the memory of the endpoint within the time threshold and the malware detection system 200 generates another create-load event for it. This second event is associated with the “windowsCodecs.dll” file. Finally, the Qbot creates a “Qbot.dll” file on that same endpoint. The “Qbot.dll” file is loaded into the memory of the endpoint within the time threshold and the malware detection system 200 generates another create-load event for it. This third event is associated with the “Qbot.dll” file. The malware detection system 200 determines probability indicators for each of the three create-load events of this non-limiting example by utilizing one or more of the evidence scoring rules. In our non-limiting example, we will assume that each file was the only file created by the creating file, thus the evidence scoring rule stating that the probability indicator is greater upon the file associated with the respective create-load event is an only file created by another file is triggered and the probability indicator determined for each of these three create-load events is above the threshold, thereby alerting a user of the malware detection system 200 that a malware attack is being conducted on the given endpoint.

According to certain examples of the presently disclosed subject matter, malware detection system 200 can be configured to perform a malware detection process 300, e.g., utilizing the create-load malware detection module 240.

For this purpose, malware detection system 200 can be configured to obtain a log of events occurring on the endpoint during a first time-window and during a second time-window (block 310). It is to be noted that the log can be obtained by the malware detection system 200 in a periodically or continuously manner.

A non-limiting example is of the log comprising create file events (or file creation attempt events) and load file events (or load file attempts events).

It is to be noted that in some cases, the malware detection system 200 can be an Endpoint Detection and Response (EDR) system monitoring endpoints connected through the organizational network, a Security Information and Events Management (SIEM) system, or any other malware detection system. The endpoints monitored can be devices, firewalls, servers, IoT devices or any other asset of the organization. In some cases, malware detection system 200 performs the entire malware detection process 300 on a given endpoint of the organizational network. In other cases, the malware detection process 300 can collect the events information from one or more endpoints of the organizational network and process the information in a central location or in a distributed manner or on one or more cloud computing platforms or in any other manner or combination thereof. In some cases, at least some of the information is obtained by an agent installed on the assets of the organizational network. In some cases, at least some of the information is retrieved by proactively querying one or more assets of the organizational network. For example, when malware detection system 200 lacks actual events information for identifying the cyber techniques it can query an asset where the needed information can be found.

After obtaining a log of events occurring on the endpoint, the malware detection system 200 can be further configured to obtain a file creation list being a list of files created or attempted to be created on the endpoint during the first time-window and a respective time of creation or attempted creation of each file in the list; wherein the file creation list can be based on an analysis of the log (block 320). Continuing our non-limiting example above, malware detection system 200 obtains a file creation list comprising entries for the three files created on the given endpoint: the “calc.exe” file, the “windowsCodecs.dll” file and the “Qbot.dll” file. Each entry with a respective timestamp when these files were created on the given endpoint.

The malware detection system 200 can than obtain a file load list being a list of files loaded or attempted to be loaded into the memory of the endpoint during a second time-window and a respective time of loading or attempted loading of each file in the list into the memory; wherein the file load list can be based on the analysis of the log (block 330). It is to be noted that the first time-window and the second time-window can differ, overlap or be identical.

Continuing our non-limiting example above, malware detection system 200 obtains a file load list comprising entries for the three files loaded on the given endpoint: the “calc.exe” file, the “windowsCodecs.dll” file and the “Qbot.dll” file. Each entry with a respective timestamp when these files were loaded into the memory of the given endpoint

After obtaining the file creation list and the file load list, the malware detection system 200 can generate one or more create-load events, each generated upon determining at least one file being loaded or attempted to be loaded into a memory of an endpoint before a pre-determined period of time passing from creation of the file on the endpoint, each create-load event is associated with the respective file; wherein the generation of the create-load events can be based on an analysis of the file creation list and the file load list (block 340). It is to be noted that the file creation list and the file load list can be obtained by malware detection system 200, periodically or continuously and that the generation of the create-load events and following actions can be performed periodically or continuously while maintaining at least part of the previously identified create-load events.

Continuing our non-limiting example above, we assume that the time between the creation events and the load events for all three files are below the pre-determined period of time (for example: below 30 minutes), thereby the malware detection system 200 generates three create-load event—one for each of the three files.

After generating one or more create-load events, malware detection system 200 can determine, utilizing one or more evidence scoring rules, a probability indicator for at least some of the create-load events, the probability indicator being indicative of a probability that the file associated with the respective create-load event comprises malicious code (block 350). It is to be noted that the probability indicator can be determined by the malware detection system 200 in reference to probability indicators determined for the same file type in historical data and/or in reference to probability indicators of other files determined previously by the system 200.

The one or more evidence scoring rules can include one or more of the following rules in any combination: the probability indicator is greater upon the file associated with the respective create-load event is an only file created by another file, the probability indicator is greater upon the file associated with the respective create-load event is created by another file and a number of files created by the another file is below a number of created files threshold (for example: below 3), the probability indicator is greater upon the file associated with the respective create-load event is part of a group of files above a group size threshold wherein the group size is the number of files in a group of files comprises one or more files that: were created on the endpoint, and/or were created within a third time-window, and/or have a given integrity level, the probability indicator is greater upon the execution of the file associated with the respective create-load event includes communicating with the internet, the probability indicator is greater upon the execution of a child-file created by the file associated with the respective create-load event includes communicating with the internet, the probability indicator is greater upon the execution of the file associated with the respective create-load event includes persistence wherein the execution of the file associated with the respective create-load event make an action on the endpoint or on another endpoint that will lead to a future execution of the file itself or of another piece of software associated with the file, or the probability indicator is greater upon the execution of a child-file created by the file associated with the respective create-load event includes persistence wherein the execution of the file associated with the respective create-load event make an action on the endpoint or on another endpoint that will lead to a future execution of the file itself or of another piece of software associated with the file.

Continuing the non-limiting example, the malware detection system 200 can use one or more of the evidence scoring rules to determine the probability indicator of each of the three generated create-load events. Malware detection system 200 can use weights to give different importance to each of the rules. The weights can be dynamically influenced by the parameters associated with the create-load events and/or with the parameters associated with the create and load events that led to the generation of the create-load event.

Malware detection system 200 can be further configured to alert a user of the malware detection system upon the probability indicator of at least one create-load event being above a threshold (block 360).

In some cases, malware detection system 200 can be optionally further configured to recognize patterns within the one or more create-load events having probability indicator above a second threshold (block 370). Malware detection system 200 can optionally recognize patterns within the one or more create-load events having probability indicator above a second threshold. These patterns can include a create-load event that is reoccurring every period of time (such as: every day, every week, on specific times, etc.). For a non-limiting example, malware detection system 200 can look at create-load events having probability indicator above a certain threshold and recognize that they all occur on weekends-when the network is less loaded and the malware tries to remain undetected. These recognized patterns can be reported by the malware detection system 200 to a user of the system.

It is to be noted that the log and the create list and the load list information can be obtained periodically or continuously by malware detection system 200 and that the generate step (block 340), the determine step (block 350), the alert step (block 360) and the pattern recognition step (block 370) can be performed periodically or continuously while maintaining previously identified implemented cyber techniques. Continuing our non-limiting example, the information leading to the generation of the first create-load event can be obtained during a first period, maintained by malware detection system 200, for example, by storing the actual events in data repository 210 and the information leading to the generation of the second and third create-load events can be obtained only at a later period. Malware detection system 200 will be able to use all these pieces of information to identify the occurrence of the malware attack and to alert the user of the system 200.

It is to be noted that, with reference to FIG. 3, some of the blocks can be integrated into a consolidated block or can be broken down to a few blocks and/or other blocks may be added. Furthermore, in some cases, the blocks can be performed in a different order than described. It is to be further noted that some of the blocks are optional (for example: blocks 310, 320, 360 and 370). It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A malware detection system comprising a processing circuitry configured to:
generate one or more create-load events, each generated upon determining at least one file being loaded or attempted to be loaded into a memory of an endpoint before a pre-determined period of time passing from creation of the file on the endpoint, each create-load event is associated with the respective file;
determine, utilizing one or more evidence scoring rules, a probability indicator for at least some of the create-load events, the probability indicator being indicative of a probability that the file associated with the respective create-load event comprises malicious code; and
alert a user of the malware detection system upon the probability indicator of at least one create-load event being above a threshold.

2. The malware detection system of claim 1, wherein the processing circuitry is further configured to:
obtain a file creation list being a list of files created or attempted to be created on the endpoint during a first time-window and a respective time of creation or attempted creation of each file in the list;
obtain a file load list being a list of files loaded or attempted to be loaded into the memory of the endpoint during a second time-window and a respective time of loading or attempted loading of each file in the list into the memory; and
wherein the generate is based on an analysis of the file creation list and the file load list.

3. The malware detection system of claim 2, wherein the processing circuitry is further configured to:
obtain a log of events occurring on the endpoint during the first time-window and during the second time-window; and
wherein the file creation list and the file load list are based on an analysis of the log.

4. The malware detection system of claim 2, wherein the first time-window and the second time-window are identical.

5. The malware detection system of claim 2, wherein the file creation list and the file load list are obtained periodically or continuously and wherein the generate, the determine and the alert are performed periodically or continuously while maintaining at least part of the previously identified create-load events.

6. The malware detection system of claim 3, wherein the log is obtained periodically or continuously.

7. The malware detection system of claim 1, wherein the one or more evidence scoring rules include one or more of:
(a) the probability indicator is greater upon the file associated with the respective create-load event is an only file created by another file;
(b) the probability indicator is greater upon the file associated with the respective create-load event is created by another file and a number of files created by the another file is below a number of created files threshold;
(c) the probability indicator is greater upon the file associated with the respective create-load event is part of a group of files above a group size threshold;
(d) the probability indicator is greater upon the execution of the file associated with the respective create-load event includes communicating with the internet;
(e) the probability indicator is greater upon the execution of a child-file created by the file associated with the respective create-load event includes communicating with the internet;
(f) the probability indicator is greater upon the execution of the file associated with the respective create-load event includes persistence; or
(g) the probability indicator is greater upon the execution of a child-file created by the file associated with the respective create-load event includes persistence.

8. The malware detection system of claim 7, wherein the group of files comprises one or more files that: (a) were created on the endpoint, (b) were created within a third time-window, and (c) have a given integrity level.

9. The malware detection system of claim 1, wherein the processing circuitry is further configured to:
recognize patterns within the one or more create-load events having probability indicator above a second threshold.

10. A malware detection method comprising:
generating, by a processing circuitry, one or more create-load events, each generated upon determining at least one file being loaded or attempted to be loaded into a memory of an endpoint before a pre-determined period of time passing from creation of the file on the endpoint, each create-load event is associated with the respective file;
determining, by the processing circuitry, utilizing one or more evidence scoring rules, a probability indicator for at least some of the create-load events, the probability indicator being indicative of a probability that the file associated with the respective create-load event comprises malicious code; and
alerting, by the processing circuitry, a user of the malware detection system upon the probability indicator of at least one create-load event being above a threshold.

11. The malware detection method of claim 10, further comprising:
obtaining, by the processing circuitry, a file creation list being a list of files created or attempted to be created on the endpoint during a first time-window and a respective time of creation or attempted creation of each file in the list;
obtaining, by the processing circuitry, a file load list being a list of files loaded or attempted to be loaded into the memory of the endpoint during a second time-window and a respective time of loading or attempted loading of each file in the list into the memory; and
wherein the generating is based on an analysis of the file creation list and the file load list.

12. The malware detection method of claim 11, further comprising:
obtaining, by the processing circuitry, a log of events occurring on the endpoint during the first time-window and during the second time-window; and
wherein the file creation list and the file load list are based on an analysis of the log.

13. The malware detection method of claim 11, wherein the first time-window and the second time-window are identical.

14. The malware detection method of claim 11, wherein the file creation list and the file load list are obtained periodically or continuously and wherein the generating, the determining and the alerting are performed periodically or continuously while maintaining at least part of the previously identified create-load events.

15. The malware detection method of claim 12, wherein the log is obtained periodically or continuously.

16. The malware detection method of claim 10, wherein the one or more evidence scoring rules include one or more of:
(a) the probability indicator is greater upon the file associated with the respective create-load event is an only file created by another file;
(b) the probability indicator is greater upon the file associated with the respective create-load event is created by another file and a number of files created by the another file is below a number of created files threshold;
(c) the probability indicator is greater upon the file associated with the respective create-load event is part of a group of files above a group size threshold;
(d) the probability indicator is greater upon the execution of the file associated with the respective create-load event includes communicating with the internet;
(e) the probability indicator is greater upon the execution of a child-file created by the file associated with the respective create-load event includes communicating with the internet;
(f) the probability indicator is greater upon the execution of the file associated with the respective create-load event includes persistence; or
(g) the probability indicator is greater upon the execution of a child-file created by the file associated with the respective create-load event includes persistence.

17. The malware detection method of claim 16, wherein the group of files comprises one or more files that: (a) were created on the endpoint, (b) were created within a third time-window, and (c) have a given integrity level.

18. The malware detection method of claim 10, further comprising:
recognizing, by the processing circuitry, patterns within the one or more create-load events having probability indicator above a second threshold.

19. A non-transitory computer readable storage medium having computer readable program code embodied therewith, the computer readable program code, executable by processing circuitry of a computer to perform a malware detection method, the malware detection method comprising:
generating, by a processing circuitry, one or more create-load events, each generated upon determining at least one file being loaded or attempted to be loaded into a memory of an endpoint before a pre-determined period of time passing from creation of the file on the endpoint, each create-load event is associated with the respective file;
determining, by the processing circuitry, utilizing one or more evidence scoring rules, a probability indicator for at least some of the create-load events, the probability indicator being indicative of a probability that the file associated with the respective create-load event comprises malicious code; and
alerting, by the processing circuitry, a user of the malware detection system upon the probability indicator of at least one create-load event being above a threshold.
